(19) United States
(12) Patent Application Publication
(10) Pub. No.: US 2005/0190817 A1
(43) Pub. Date: Sep. 1, 2005

(54) System and method for unified channelization for multi-band OFDM

(76) Inventors: Anuj Batra, Dallas, TX (US); Jaiganesh Balakrishnan, Bangalore (IN); Jin-Meng Ho, Plano, TX (US)

Correspondence Address: TEXAS INSTRUMENTS INCORPORATED, P O BOX 655474, M/S 3999, DALLAS, TX, 75265, US

(21) Appl. No.: 11/053,306

(22) Filed: Feb. 7, 2005

Related U.S. Application Data
(60) Provisional application No. 60/543,339, filed on Feb. 9, 2004.

(51) Int. Cl. H04B 1/69

(52) U.S. Cl. 375/130

(57) ABSTRACT

A system and method for channelization and data multiplexing in ultra-wideband (UWB) wireless communication system is described. The spectrum allocated for UWB in a multi-bank OFDM (orthogonal frequency division multiplex) system is subdivided into various bands. A set of time frequency codes (TFC's) is defined, wherein each code specifies one of a plurality of unique band versus time sequences for a particular band group, for sequential data symbols of a given piconet. The combination of FDMA and TFC's provides a data complexing system supporting up to 30 simultaneously operating piconets, and a simplified interface between the MAC and PHY.

### CROSS-REFERENCE TO RELATED APPLICATIONS

This application is related to and claims priority from U.S. Provisional Patent Application Ser. No. 60/543,339 filed on Feb. 09, 2004. This application is also related to U.S. patent application Ser. No. 11/032,402 filed on Jan. 10, 2005. Disclosures of these applications are incorporated herein by references in their entirety for all purposes.

### BACKGROUND

1. Field of the Invention

This disclosure relates to ultra-wideband (UWB) wireless communication systems in general, and, in particular, to a channelization and data multiplexing system providing multiple user or device access to shared spectrum using a multi-band orthogonal frequency division multiplex (OFDM) system.

2. Description of the Related Art

Unlicensed wireless data communications systems such as WiFi (802.11b, 802.11g) have found wide acceptance, connecting PC's and digital appliances such as digital cameras, video cameras, and PDA's to each other and to internet gateways. Performance of wireless systems is typically affected by choice of frequency, bandwidth, modulation type, data multiplexing type, data rate, and power level. Design tradeoffs considering these parameters have a significant impact on the complexity of hardware and software, and can affect cost, size, and power consumption. It is generally desirable to maximize data rates, number of simultaneous users, and range, while minimizing transmit power and hardware complexity.

A type of wireless system, ultra-wideband (UWB), has an occupied bandwidth much wider than many traditional systems. The spectrum allocated in the United States for UWB is from 3,100 MHz to 10,600 MHz (7,500 MHz bandwidth); contrast this with the 20 MHz bandwidth allocated for US commercial FM broadcasting. Wireless communication systems using UWB technology typically provide multiple time division duplex (TDD) data sessions among users or devices. Data multiplexing provides shared access to the communication system for multiple users or devices. Widely used forms of multiplexing include frequency division multiple access (FDMA), where signals or data streams are each modulated onto unique portions of spectrum, and time division multiple access (TDMA), where data packets from different users or devices are assigned unique time slots in the same portion of spectrum.

A known art approach to data multiplexing in a UWB system uses code division multiple access (CDMA), a direct-sequence spread-spectrum system also used in cellular telephony, wireless LAN, and many other applications. CDMA first modifies the user data to be transmitted by multiplying it with a unique pseudo-noise (PN) spreading code having a bit width typically 5 to 20 times narrower (in time) than the user data bit width. The resultant digital signal, now at a much higher chip rate than the original data rate, is modulated onto a radio-frequency (RF) carrier. The high data rate of the PN code, compared to the user data rate, spreads the coded information across a much wider portion of spectrum. Each user or device is given a unique spreading code to differentiate its data stream from other users or devices data streams. At the receiver, the original data is recovered by de-spreading using this unique PN code.

CDMA systems with bandwidth in the GHz range pose stringent demands on transmit and receive hardware, which are generally difficult and costly to meet. Wideband UWB CDMA typically requires very high speed RF and analog circuits, as well as very high speed analog to digital (A/D) and digital to analog (D/A) converters. Complex digital circuitry is required to capture sufficient multipath energy to provide acceptable link range. CDMA also increases the probability of interference from one device to another as the number of devices in the shared spectrum increases.

Some wireless communications systems are designed to support simultaneous data transmission among multiple devices and multiple groups of devices. A group or network of devices having data connection among each other is sometimes referred to as a piconet. A piconet is a logical group of two or more devices communicating with each other, without interference from other piconets even in close proximity. An example piconet might be a digital camera with UWB connection to a PC, downloading images to the PC. Another might be a DVD player with a UWB wireless link to a television display.

In UWB systems it is often advantageous to support as many simultaneously operating piconets (SOP's) as possible. Multiple SOP's typically require that data packets or symbols from devices on each SOP are multiplexed in a manner so data packets from one SOP are not readable to other SOP's. While known UWB multiplexing schemes support multiple SOP's, an alternative channelization and multiplexing scheme increasing the number of SOP's would be beneficial.

The choice of channelization and multiplexing also impacts the logical connection between the medium access controller (MAC) and the physical layer (PHY). The MAC assigns a unique data path to each of the data streams or piconets. These data paths are then mapped, in the PHY, to the physical characteristics necessary to affect minimally interfering multiplexing of the data. These characteristics might include spreading code in a CDMA system, frequency in a FDMA system, time slot in a TDMA system, or some combination thereof. It is desirable to simplify the interface between the MAC and the PHY.

### SUMMARY

The present application describes a method and system for channelization of spectrum and multiplexing of data in a multi-band OFDM wireless communication system, providing improved support of multiple SOP's, and a simplified interface between the MAC and the PHY. The UWB spectrum (3,100 MHz to 10,600 MHz) is subdivided into 528 MHz wide bands, which are then grouped into band groups each having two or more adjacent bands. In some embodiment, the user data is modulated onto a plurality of OFDM data tones in one of the 528 MHz bands, and the band used to transmit the OFDM symbols for a given piconet either changes with time in a defined sequence or remains static. Within each band group, the sequence of bands or the single band used for a particular piconet is defined by a time-frequency code (TFC). The disclosure describes a novel combination of FDMA and time-frequency codes, enabling support of a larger number of SOP's. Additional advantages over known art include the ability to tailor the frequency bands to specific regions or countries to mitigate interference with existing wireless services, and the separation of types of service by frequency, allowing optimization of bands used for given data rate and range requirements.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

FIG. 1 is a chart of a multi-band OFDM band plan from 3.1 GHz to 10.6 GHz, detailing frequencies of bands and groups of 2 or 3 bands into each of 5 band groups.

FIG. 2 is a chart showing four time-frequency codes (TFC's) and corresponding repeating sequence of band numbers for successive data symbols, each TFC varying the band used as a function of time.

FIG. 3 is a chart showing three time-frequency codes (TFC's) and corresponding repeating sequence of band numbers for successive data symbols, each TFC being non-varying as a function of time.

FIG. 4 is a chart showing the combined seven time-frequency codes (TFC's), corresponding time-frequency code patterns (four time varying, three static), and corresponding preamble pattern numbers. Also shown is a logic circuit for generating the preamble pattern number.

FIG. 5 is a block diagram of a data transmitter using band groups and time varying or static frequency bands (controlled by time frequency codes), to separate and multiplex a plurality of data streams from unique piconets.

FIG. 6 is a table showing the mapping from MAC channel number to PHY band group and TF code.

### DETAILED DESCRIPTION

The description that follows presents a series of systems, apparati, methods and techniques that facilitate additional local register storage through the use of a virtual register set in a processor. While much of the description herein assumes a single processor, process or thread context, some realizations in accordance with the present invention provide expanded internal register capability customizable for each processor of a multiprocessor, each process and/or each thread of execution. Accordingly, in view of the above, and without limitation, certain exemplary exploitations are now described.

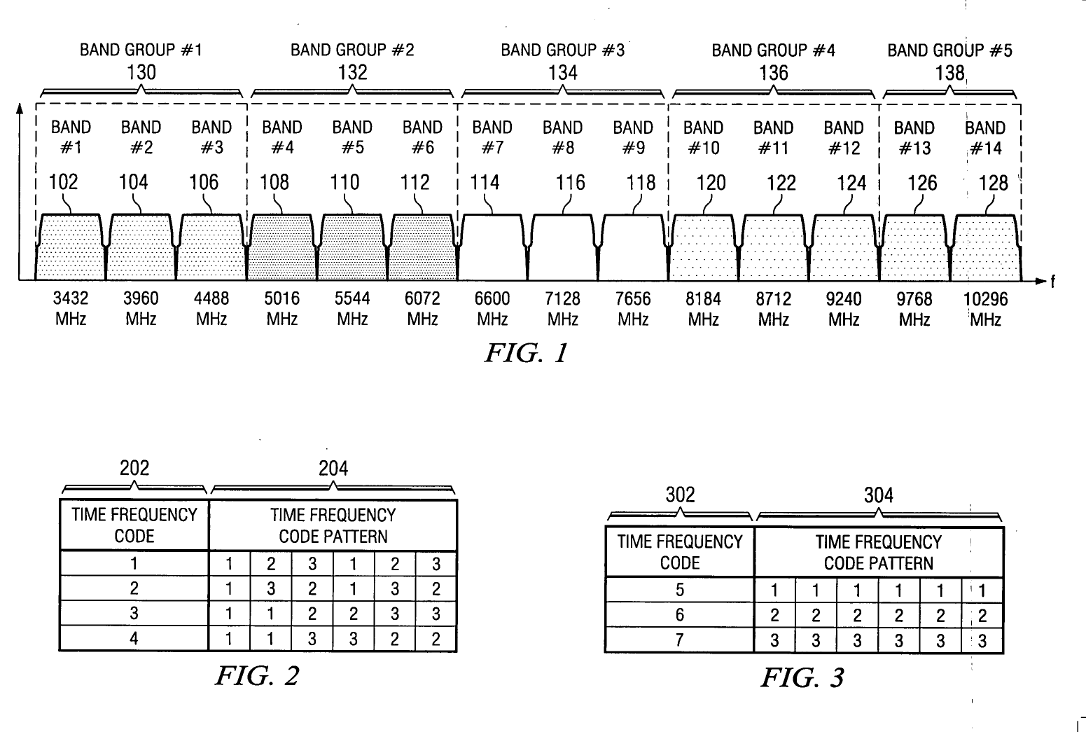

FIG. 1 illustrates a band plan for multi-band OFDM detailing fourteen bands (102-128), each 528 MHz wide, in the spectral range 3.1 GHz to 10.6 GHz. These bands are further grouped into five band groups. Band group 130 including bands 102, 104, 106; band group 132 including bands 108, 110, 112; band group 134 including bands 114, 116, 118; band group 136 including bands 120, 122, 124; and band group 138 including bands 126, 128. There are significant advantages for having four adjacent groups of three bands. Path loss at lower frequencies is less than at higher frequencies, making the lower bands typically preferred. Some hardware implementations of UWB PHY can use only one band group, (typically the lowest 130), but other PHY implementations can use multiple band groups. The design of a PHY supporting multiple band groups is significantly simplified by the fact that band groups 130 through 136 all have the same bandwidth. Therefore, the PHY transmitter or receiver can tune to any of the first 4 band groups by simply changing a local oscillator frequency. Common filtering and processing before upconversion (at transmitter) or after downconverion (at receiver) is applied to a 528 MHz wide band regardless of band group chosen thus reducing circuit complexity. The center frequency of each band is given by the formula
FC(N)=3432+528*(N−1)MHZ
where FC(N) is the center frequency of band N.

Coded bits are aggregated into groups of typically 100 or 200 bits each. Pairs of bits within a group are modulated, using known modulation techniques such as quadrature phase shift keying (QPSK), onto data tones, typically 100, generally equally spaced in one of the 528 MHz bands. Symbols associated with a unique piconet are assigned a specific one of the 5 band groups, and are further assigned a unique time-frequency code within the assigned band group. The band assigned for successive symbols either changes with time or remains constant according to a time frequency code.

FIG. 2 shows the time-frequency code (TFC) patterns 204 for four TF codes 202 which spread data symbols for a given piconet over all available bands in a band group. The code patterns determine which of the 3 available bands in a band group are used for successive data symbols from a given piconet. For example, given band group 130 and examining TFC 1, data symbols are transmitted sequentially in band 1 (102), band 2 (104), band 3 (106), band 1 (102), band 2 (104), band 3 (106); repeating indefinitely. The same TFC 1 used in band group 2 transmits data sequentially in band 4 (108), band 5 (110), band 6 (112), band 4 (108), band 5 (110), band 6 (112). The TFC's of FIG. 2 all use 3 bands, thus are used in any of those band groups with 3 bands (130, 132, 134, and 136).

Each piconet is assigned one of the band groups and a unique TFC within that band group. In each band group having three bands (130, 132, 134, 136), up to four. simultaneously operating piconets (SOP's) can operate with statistically acceptable interference one from the other. The TFC's are chosen to minimize interference caused by more than one device transmitting in the same band at the same time. When all TFC's of FIG. 2 are in use, over the 6-symbol repeat period, interference to a particular piconet or device is typically present ⅓ of the time. Interference is mitigated through the use of error correcting coding of the data within the symbols and repetitive transmission of data, as commonly used in other impaired communication channels.

FIG. 3 shows three additional time-frequency codes 302 and corresponding TFC patterns 304 which statically assign all data symbols for a given piconet to a single band of those available in a band group. This novel frequency division multiple access (FDMA) supports an additional 3 piconets for each band group, for a total of 7 uniquely defined piconets in each of the 4 band groups having 3 bands. There is minimal interference among piconets using these static time-frequency codes, since none of the three piconets ever share the same frequency band. Interference from and into piconets using TFC 1 through 4 (using all 3 bands of the band group) is, however, present when TFC 1, 2, 3 and/or 4 are used concurrently with TFC 5, 6 and/or 7. The combination of band group and time-frequency code therefore uniquely identifies a data path assigned to a given piconet.

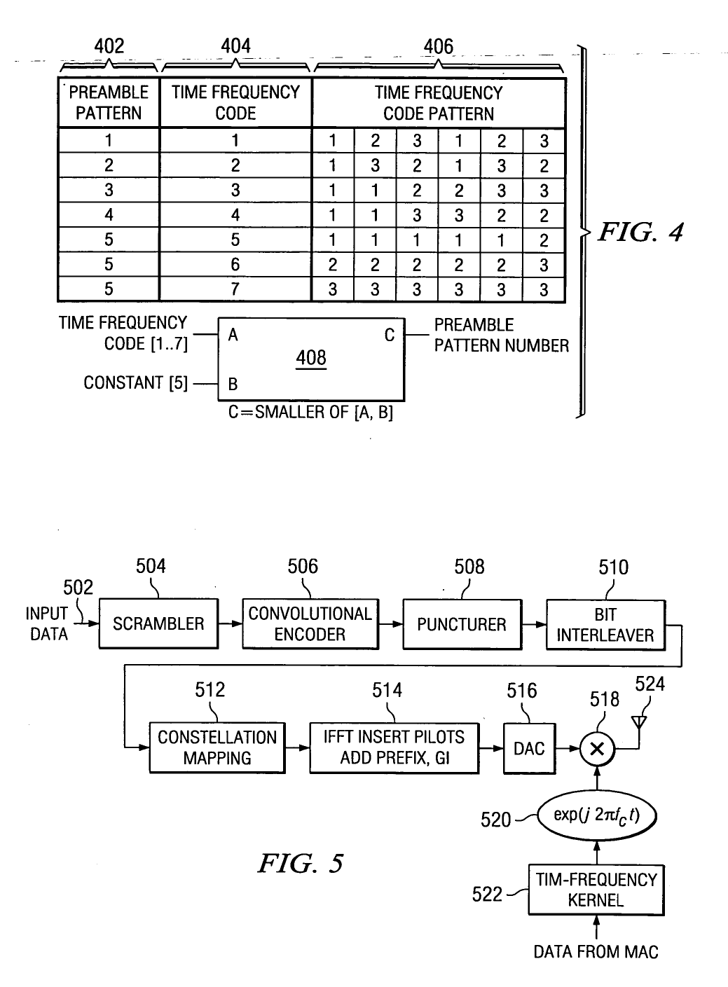

FIG. 4 shows the mapping of preamble patterns 402 to time frequency codes 404 and TFC patterns 406, for those band groups (130, 132, 134, 136) having three bands. A preamble is a set of data bits appended to each packet by the MAC, and aids in packet detection, synchronization, and timing/frequency estimation. Note in 402 and 404 that the preamble pattern number and TF code number are the same for TF Code 1 through 5; for TF codes 6 and 7 the preamble remains at 5. The logic element 408 shows how the preamble can be generated by simply taking the smaller of <TF code> and <5>. The preamble, band group, and TFC are assigned to each piconet by the MAC; these three parameters define to the PHY where in the available spectrum to place each data symbol. The four band groups and seven TFC's in each provide 28 possible combinations uniquely described by combining the preamble, band group number, and TFC. The MAC sends a single byte (8 bits) to the PHY to convey which of these 28 combinations to use.

Alternative embodiments might use different TFC sequences, even those statistically more prone to interference from others sharing the band group; might divide the allocated spectrum into larger or smaller segments or bands; might group more or fewer bands in each band group; or might use other slight differences while retaining the advantages of combining FDMA and time-frequency codes. Data from multiple SOP's is thus separated by each SOP having a unique combination of band group and TFC coding. Each user, device or SOP is assigned a band group, and is further assigned by the TFC either a static or time-varying band to use within that assigned band group.

FIG. 5 is a block diagram of one embodiment using the channelization and time frequency codes described above. User data at Input Data 502 from a unique user or device or piconet is input to Scrambler 504, which, using known techniques, whitens the data to secure it. Convolutional coding is then applied to the data by Convolutional Encoder 506, to facilitate error detection and correction at the receiver. The data is then further modified by puncturing (removing certain bits from the data packets) in Puncturer 508. Bit interleaving of the data is then applied in Bit Interleaver 510, to spread (in time) bits from a given user data packet over a plurality of OFDM symbols. “The output of Bit Interleave 510 is a data stream of typically 200-bits (or 100 bits, depending on the input data rate). These bits are applied to a Constellation Mapping 512, which assigns to each N-bit segment a unique point (or 2N-bit segment to multiple unique points), called a data symbol, in the modulation constellation. The data symbols are then mapped onto a unique frequency tone.” For example, QPSK modulation has a 4-point constellation, and each 2-bit data segment is mapped to one of the 4 points. Data then is input to the Inverse Fast Fourier Transform (IFFT) circuit 514, where data describing pilot tones and other ancillary data is added. The IFFT then converts data describing the frequency domain characteristics of the signal to data describing the time domain characteristics of the signal. The time domain data from IFFT 514 is then applied to Digital to Analog Converter (DAC) 516 for conversion to an analog signal.

This baseband analog signal out of DAC 516 thus has user data QPSK modulated onto 100 tones spaced at 4.125 MHz, plus 28 guard, pilot and null tones, also at 4.125 MHz spacing, creating a baseband OFDM signal in the 0 to 528 MHz range at the output of DAC 516. The baseband OFDM signal from DAC 516 is input to one input of multiplier 518. The other input of multiplier 518 is a band center frequency signal from synthesized generator 520. The output of multiplier 518 is the sum of the generator 520 frequency and the baseband input from DAC 516. The baseband OFDM signal is thus upconverted to one of the 14 bands of FIG. 1, and is output at antenna 524. Synthesized generator 520 typically uses addition or subtraction of a plurality of reference signals to create one of a multiplicity of frequencies. The frequency of generator 520, thus which of the 14 bands is used for a given data symbol, is controlled by frequency control data from time frequency code (TFC) sequence generator referred to as Time-Frequency Kernel 522.

The Time-Frequency Kernel 522 has as its inputs a time frequency code and a band group number from the MAC (medium access controller), which preamble and band group, in combination, are unique to a specific piconet, user or device inputting data to input 502. Successive user data symbols are transmitted sequentially in all the bands (for example, bands 102, 104, 106 of band group 130 in FIG. 1) of the assigned band group. The unique time sequence of bands for a give user is determined by a table mapping the combination of band group number and time frequency code, which is a repeating series of band numbers for the band group. Typically, the data is received as an octet including a predetermined bit pattern reflecting the band group and time-frequency codes. According to an embodiment, three consecutive bits within an octet, specify a band group and three consecutive bits within the same octet defined as an “a” specify the time-frequency code. These six bits define the channel number. The time frequency code maps to a unique preamble.

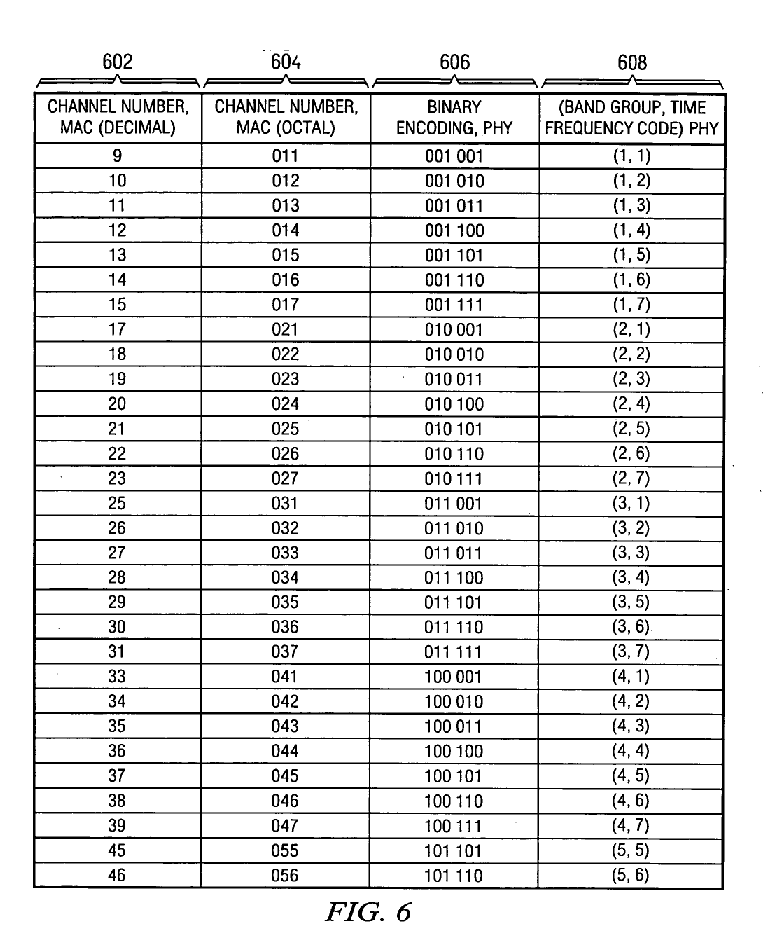

FIG. 6 shows the mapping of MAC Channel Number to PHY Band Group and TF Code. The combination of 5 band groups as defined above, and up to 7 TF Codes in each band group, yields 30 uniquely defined MAC channels. The MAC could send a 5-bit word (range decimal 0-31) to the PHY to instruct the PHY which of the 30 channels to use, but doing so would require a look-up table in the PHY to convert to the appropriate Band Group number and TF Code number. In the preferred embodiment as described in FIG. 6, the MAC sends to the PHY a 6-bit word, with 3 bits used to select Band Group in the range decimal 1-5, and 3 bits used to select TF Code in the range decimal 1-7. The hardware which controls Band Group in the PHY need only look at the first set of 3 bits; the hardware which controls TF Code in the PHY need only look at the second set of 3 bits. This masking of the 6 bits into two sets of 3 bits avoids the need for a lookup table, provides a very simple interface between the MAC and PHY, and reduces the logic required in the PHY.

The example embodiment described in the figures and accompanying descriptions is but one of many possible variations in band group definition, TFC structure, or modulation technique, all providing improved support of multiple SOP's through the novel combination of frequency division multiple access (FDMA) and static or time-varying time-frequency codes (TFC). Those skilled in the art to which the invention relates will appreciate that yet other substitutions and modifications can be made to the described embodiments, without departing from the spirit and scope of the invention as described by the claims below.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

1. A method of communication in a wireless network using ultra-wideband (UWB) spectrum, the wireless network comprising one or more simultaneously operating pico networks, the method comprising:
dividing the UWB spectrum into a plurality of frequency bands;
forming at least four band groups each including at least three frequency bands, and at least one band group including at least two frequency bands;
assigning at least one band group to each one of the pico networks;
assigning at least one time frequency code to symbols associated with each one of the pico networks, wherein the time frequency code represents one of a single frequency band and a pre-defined sequencing across all the frequency bands within the assigned band group;
communicating data within each one of the pico networks using the assigned band groups according to the time frequency code, wherein
each one of the band groups including at least three frequency bands further includes at least seven time frequency codes and the band group including at least two frequency bands further includes at least two time frequency codes.

2. A method according to claim 1, wherein at least four of the seven time frequency codes within each one of the band group, including at least three frequency bands, are time-varying time-frequency codes configured to use each one of the frequency band within the band group for associated successive symbols of corresponding pico network.

3. A method according to claim 1, wherein the time frequency codes within each one of the band group, including at least two frequency bands, are static time frequency codes assigned to a predetermined frequency band within the band group for associated successive symbols of corresponding pico network.

4. A method according to claim 1, wherein each frequency band is 528 MHz wide.

5. A method according to claim 4, wherein a center frequency of each frequency band is given by:
FC(N)=3432+528*(N−1)MHz,
wherein FC(N) is the center frequency of band N.

6. A method according to claim 1, further comprising:
assigning a preamble to each one of the pico networks.

7. A method according to claim 5, wherein
the UWB spectrum includes at most fourteen frequency bands.

8. A system for channelization of ultra-wideband (UWB) spectrum in a wireless network using ultra-wideband (UWB) spectrum, the wireless network comprising one or more simultaneously operating pico networks, the system comprising
a frequency-synthesized oscillator configured to generate a signal in steps of 528 MHz beginning at center frequency of 3432 MHz and ending at center frequency of 10,296 MHz; and
a time frequency code generator coupled to the frequency-synthesized oscillator and configured to assign time-frequency codes to successive data symbols of a pico network such that the successive data symbols are transmitted in corresponding frequency bands of a band group according to assigned time-frequency codes, wherein
the UWB spectrum comprises at least four band groups each including at least three frequency bands, and at least one band group including at least two frequency bands, and
each one of the band groups including at least three frequency bands further includes at least seven time frequency codes and the band group including at least two frequency bands further includes at least two time frequency codes

9. A system according to claim 8, wherein the time frequency generator assigns the time-frequency codes to the data symbols according to the time frequency code and a band group number assigned to the corresponding pico network.

10. A system according to claim 8, wherein at least four of the seven time frequency codes within each one of the band group, including at least three frequency bands, are time-varying time-frequency codes configured to use each one of the frequency band within the band group for associated successive symbols of corresponding pico network.

11. A system according to claim 8, wherein the time frequency codes within each one of the band group, including at least two frequency bands, are static time frequency codes assigned to a predetermined frequency band within the band group for associated successive symbols of corresponding pico network.

12. A system according to claim 8, wherein each frequency band is 528 MHz wide.

13. A system according to claim 12, wherein a center frequency of each frequency band is given by:
FC(N)=3432+528*(N−1)MHz,
wherein FC(N) is the center frequency of band N.

14. A system according to claim 8, further comprising:
a data coding circuit coupled to the frequency-synthesized oscillator and configured to add convolutional error correcting codes to incoming data symbol, interleave across at most 1200 coded data bits and map onto data symbols;
an orthogonal frequency division multiplex (OFDM ) modulator coupled to the data coding circuit and configured to modulate the at most 100 data symbols onto at most 110 tones at 4.125 MHz spacing to create a baseband OFDM signal from DC to 528 MHz; and
a frequency multiplier coupled to the frequency-synthesized oscillator and configured to frequency shift the baseband OFDM signal one of the frequency bands.

15. A system according to claim 8, wherein the time frequency code generator generates time-frequency codes mapping to a unique preamble using a the time frequency code and a band group number such that successive symbols are transmitted in one or more frequency bands of the assigned band group.

16. A system according to claim 15, wherein the time frequency code generator is configured to generate an octet of data including at least three consecutive bits representing the band group and at least three consecutive bits representing the time frequency code.

17. A system according to claim 16, wherein band group and the time frequency code define a channel number.

18. A system according to claim 16, wherein the system is configured to determine a channel by masking the at least three consecutive bits of the octet representing the band group to determine the band group and masking the at least three consecutive bits of the octet representing the time frequency code to determine the time frequency code.
